(19) United States
(12) Patent Application Publication
(10) Pub. No.: US 2025/0071855 A1
(43) Pub. Date: Feb. 27, 2025

(54) USER EQUIPMENT TIMING ADVANCE VALIDATION WINDOW DESIGN FOR FREQUENCY RANGE 2 (FR2) SMALL DATA TRANSFER (SDT)

(71) Applicant: APPLE INC., CUPERTINO, CA (US)

(72) Inventors: Jie CUI, CUPERTINO, CA (US); Fangli XU, BEIJING (CN); Dawei ZHANG, CUPERTINO, CA (US); Hong HE, CUPERTINO, CA (US); Chunhai YAO, BEIJING (CN); Yang TANG, CUPERTINO, CA (US); Manasa RAGHAVAN, CUPERTINO, CA (US); Huaning NIU, CUPERTINO, CA (US); Xiang CHEN, CUPERTINO, CA (US); Qiming LI, BEIJING (CN)

(21) Appl. No.: 18/727,045

(22) PCT Filed: Jan. 7, 2022
(86) PCT No.: PCT/CN2022/070780

§ 371 Date: Jul. 5, 2024

(30) Foreign Application Priority Data
Jan. 7, 2022 (WO) PCT/CN2022/070780

(51) Int. Cl. H04W 76/28; H04B 7/06; H04B 17/318; H04W 24/10; H04W 56/00

(52) U.S. Cl. CPC H04W 76/28; H04B 7/06952; H04B 17/328; H04W 24/10; H04W 56/0015; H04W 56/0045

(57) ABSTRACT

Methods and apparatus for Timing Advance (TA) validation are disclosed. In some embodiments, a method for wireless communication at a user equipment (UE) comprises receiving, from a base station, configuration information, where the configuration information specifying a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, and at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation.

### CROSS-REFERENCE TO RELATED APPLICATIONS

The present application is the national phase of International Application No. PCT/CN2022/070780, filed on Jan. 7, 2022 and the disclosure of which is hereby incorporated herein by reference in its entirety.

### FIELD OF INVENTION

Embodiments described herein relate generally to wireless technology and more particularly to small data transfer (SDT) in new radio (NR) using timing advance (TA) validation windows for frequency range 2 (FR2).

### BACKGROUND

Fifth generation mobile network (5G) is a wireless standard that aims to improve upon data transmission speed, reliability, availability, and more. This standard, while still developing, includes numerous details relating to various aspects of wireless communication, for example, NR and NR in a spectrum greater than 52.6 GHz.

### SUMMARY OF THE DESCRIPTION

Methods and apparatus for Timing Advance (TA) validation are disclosed. In some embodiments, a method for wireless communication at a user equipment (UE) comprises receiving, from a base station, configuration information, where the configuration information specifying a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, and at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation. The method also includes configuring, by the UE, for use of the CG-SDT resource and the RSRP change-based method; determining if an SDT can be initiated to transmit uplink data by determining the UE is configured with the CG-SDT resource and determining whether TA is valid based on a specific timer running and based on an RSRP change associated with measured RSRP values obtained during the measurement windows for TA validation; and transmitting, in response to determining SDT can be initiated, uplink data using the CG-SDT resource while the UE is in an RRC inactive state.

In some embodiments, a baseband processor of a User Equipment (UE) is configured to perform operations of receiving, from a base station, configuration information, where the configuration information specifying a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, and at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation. The operations also include configuring, by the UE, for use of the CG-SDT resource and the RSRP change-based method; determining if an SDT can be initiated to transmit uplink data by determining the UE is configured with the CG-SDT resource and determining whether TA is valid based on a specific timer running and based on an RSRP change associated with measured RSRP values obtained during the measurement windows for TA validation; and transmitting, in response to determining SDT can be initiated, uplink data using the CG-SDT resource while the UE is in an RRC inactive state.

In some embodiments, a UE comprising one or more processors is configured to perform operations comprising receiving, from a base station, configuration information, where the configuration information specifying a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, and at least one boundary of at least one of the two measurement windows for TA validation is based on a minimum of either a Frequency Range 2(FR2) measurement period and a scaled Discontinuous Reception (DRX) cycle period, existing at time of TA validation criteria evaluation. The operations also include configuring, by the UE, for use of the CG-SDT resource and the RSRP change-based method; determining if an SDT can be initiated to transmit uplink data by determining the UE is configured with the CG-SDT resource and determining whether TA is valid based on a specific timer running and based on an RSRP change associated with measured RSRP values obtained during the measurement windows for TA validation; and transmitting, in response to determining SDT can be initiated, uplink data using the CG-SDT resource while the UE is in an RRC inactive state.

In some embodiments, a method for use in a base station comprises determining a configuration for a UE, wherein the configuration is included in configuration information that specifies a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, where at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation. The method also includes sending the configuration information to the UE and receiving uplink data from the UE sent as a SDT using the CG-SDT resource.

In some embodiments, a base station comprising one or more processors is configured to perform operations comprising determining a configuration for a UE, wherein the configuration is included in configuration information that specifies a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, where at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation. The method also includes sending the configuration information to the UE and receiving uplink data from the UE sent as a SDT using the CG-SDT resource.

In some embodiments, a baseband processor of a base station is configured to perform operations comprising determining a configuration for a UE, wherein the configuration is included in configuration information that specifies a configured grant (CG)-small data transfer (SDT) resource available for use by the UE and specifying a configuration for a Reference Signal Received Power (RSRP) change-based TA validation method to be met in order to perform a SDT while in the RRC inactive state, the RSRP change-based TA validation method having configured TA validation criteria that is evaluated based on two measurement windows for timing advance (TA) validation, where at least one boundary of at least one of the two measurement windows for TA validation is based on a minimum of either a Frequency Range 2 (FR2) measurement period and a scaled Discontinuous Reception (DRX) cycle period, existing at time of TA validation criteria evaluation. The method also includes sending the configuration information to the UE and receiving uplink data from the UE sent as a SDT using the CG-SDT resource.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry, according to some embodiments.

FIG. 6 illustrates the two windows defined for measuring the SSB RSRP

FIG. 7 is a flow diagram of an embodiment of a process for wireless communication at a user equipment (UE).

FIG. 8 is a flow diagram of an embodiment of a process for wireless communication at a base station.

FIG. 9 is a flow diagram of an embodiment of a process for wireless communication at a user equipment (UE).

FIG. 10 is a flow diagram of an embodiment of a process for wireless communication at a user equipment (UE).

### DETAILED DESCRIPTION

A method and apparatus for determining Timing Advance (TA) validation windows for determining whether a user equipment (UE) can perform a small data transfer while in the inactive state (e.g., Radio Resource Control (RRC) inactive state) are described. In some embodiments, the UE uses measurement windows for TA validation configured by a base station in response to configuration information. In some embodiments, configuration information specifies a configured grant (CG) small data transfer (SDT) resource available for use by the UE. In some embodiments, configuration information specifies a configuration for a Reference Signal Received Power (RSRP) change-based TA validation method to be met in order to perform a SDT while in the RRC inactive state. In some embodiments, the RSRP change-based TA validation method has configured TA validation criteria that is evaluated based on two timing advance (TA) validation windows, with at least one boundary of at least one of the two measurement windows for TA validation being based on a minimum of either a Frequency Range 2 (FR2) measurement period and a scaled Discontinuous Reception (DRX) cycle period, existing at time of TA validation criteria evaluation.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus for setting Timing Advance (TA) validation windows for determining whether a UE can perform a small data transfer while in the inactive state (e.g., Radio Resource Control (RRC) inactive state) are described. In some embodiments, the UE uses measurement windows for TA validation configured by a base station in response to configuration information. In some embodiments, configuration information specifies a configured grant (CG)-small data transfer (SDT) resource available for use by the UE. In some embodiments, the configuration information specifies a configuration for a Reference Signal Received Power (RSRP) change-based TA validation method to be met in order to perform a SDT while in the RRC inactive state. In some embodiments, the RSRP change-based TA validation method has configured TA validation criteria that is evaluated based on two timing advance (TA) validation windows, with at least one boundary of at least one of the two measurement windows for TA validation being based on a minimum of either a Frequency Range 2 (FR2) measurement period and a scaled Discontinuous Reception (DRX) cycle period, existing at time of TA validation criteria evaluation.

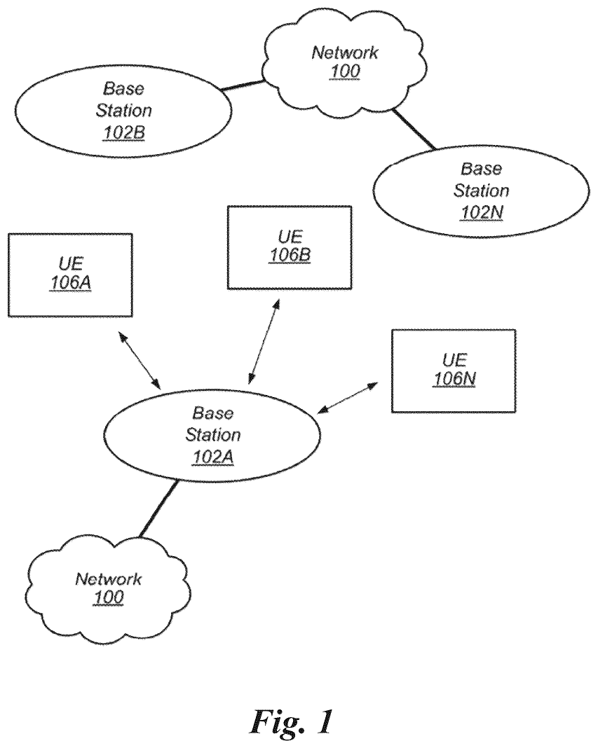

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

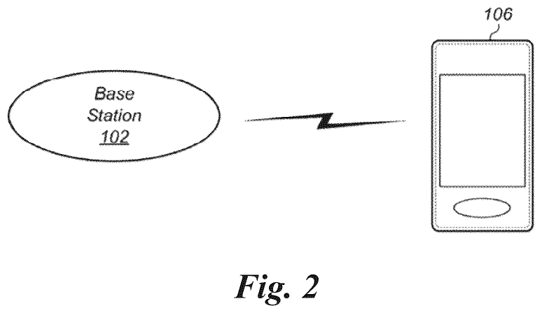

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTTor LTE or GSM), and separate radios for communicating using each of Wi-Fi and Bluetooth. Other configurations are also possible.

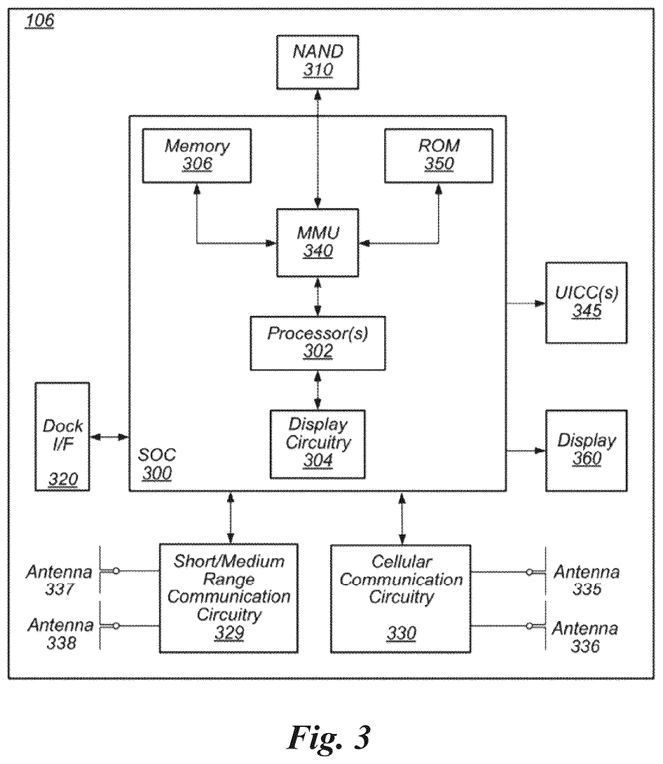

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to use Timing Advance (TA) validation windows for determining whether it can perform a small data transfer while in the RRC inactive state. In some embodiments, the UE is configured to use the measurement windows for TA validation as part of a RSRP change-based TA validation method in conjunction with a CG-SDT resource available in order to perform a SDT while in the RRC inactive state. In some embodiments, the RSRP change-based TA validation method has configured TA validation criteria that is evaluated based on two timing advance (TA) validation windows, with at least one boundary of at least one of the two measurement windows for TA validation being based on a minimum of either a Frequency Range 2 (FR2) measurement period and a scaled Discontinuous Reception (DRX) cycle period, existing at time of TA validation criteria evaluation.

As described herein, the communication device 106 may include hardware and software components for implementing the above features in order to a RSRP change-based TA validation method to enable the UE to perform a SDT while in the RRC inactive state. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

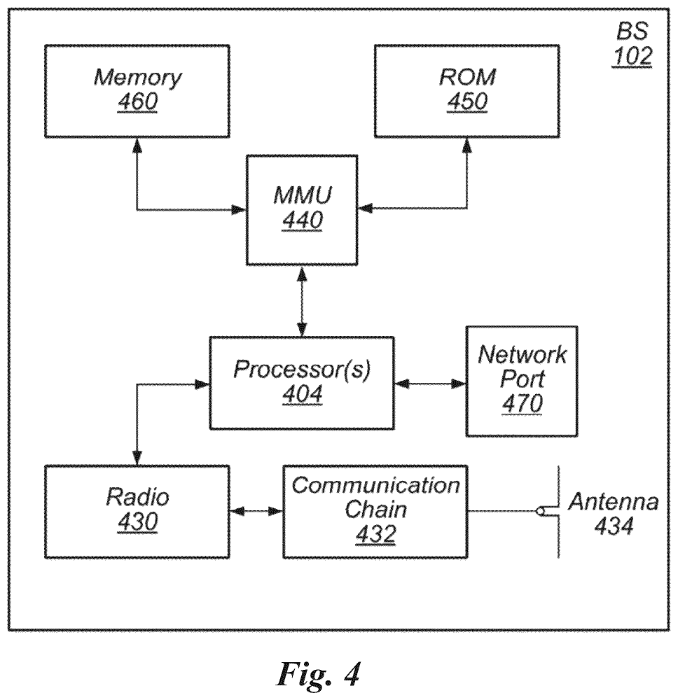

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

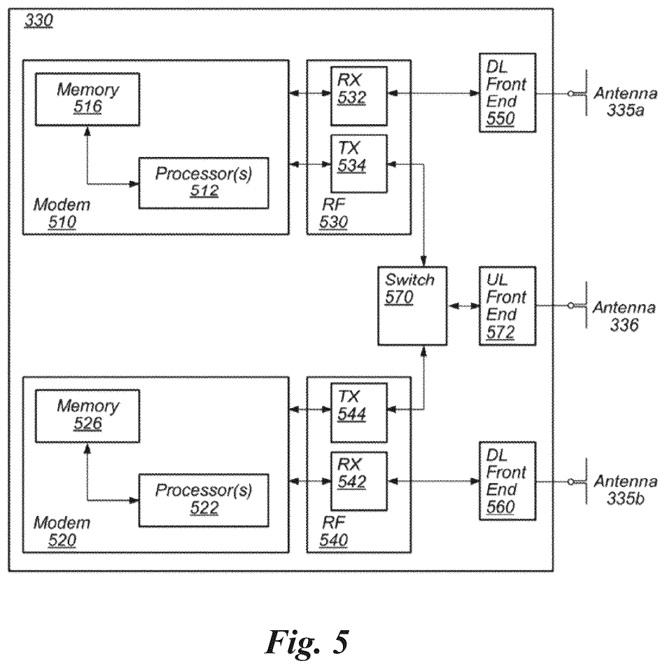

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features for using measurement windows for TA validation as part of a RSRP change-based TA validation method in conjunction with a CG-SDT resource available in order to perform a SDT while in the RRC inactive state, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for using measurement windows for TA validation as part of a RSRP change-based TA validation method in conjunction with a CG-SDT resource available in order to perform a SDT while in the RRC inactive state, as well as the various other techniques described herein, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### UE TA Validation Window Design for FR2 SDT

In some embodiments, in 5G NR, in order for a UE to transmit uplink (UL) data, the UE performs establish uplink synchronization and Radio Resource Control (RRC) connection. In order to establish uplink synchronization and RRC connection, the UE performs a Random Access Channel (RACH) procedure. The RACH procedure includes a sequence of process between UE and a base station (gNB (Network)) in order for UE to acquire uplink synchronization and obtain a specified ID for the radio access communication. The RRC uses a state machine in which a UE transitions from an RRC Inactive state to an RRC Connected state in order to transmit UL data. After transmitting UL data, the UE returns to the RRC inactive, or idle state. While the transition from the RRC inactive state to the RRC connected state to enable UL data to be transmitted is not lengthy, there are times when the UE has a small amount of data for UL and transitioning to the RRC Connected state from the RC idle state and back again is inefficient, particularly in terms of complexity and power consumption.

The 5G NR Standard has proposed having the base station transmit preconfigured UL resource information to a UE that allows the UE to be configured to use a preconfigured UL resource (e.g., a configured grant (CG) resource) to transmit UL data while in the RRC inactive state. The data comprises a small data transfer (SDT). The UL resource may be a dedicated resource (a configured grant) configured to be UE-specific for a semi-persistent scheduling operation of a UE which is in an inactive, or idle, mode. In some embodiments, the UL resource information also comprises criteria that must be fulfilled in order for the UE to use the configured grant for SDT. The preconfigured UL resource information may be transmitted through RRC signaling. Since the information related to the preconfigured UL resource is transmitted through radio resource control (RRC) signaling, the UE may be configured so that the UE may transmit uplink data in the RRC inactive state. Therefore, the techniques disclosed herein reduce complexity and power consumption.

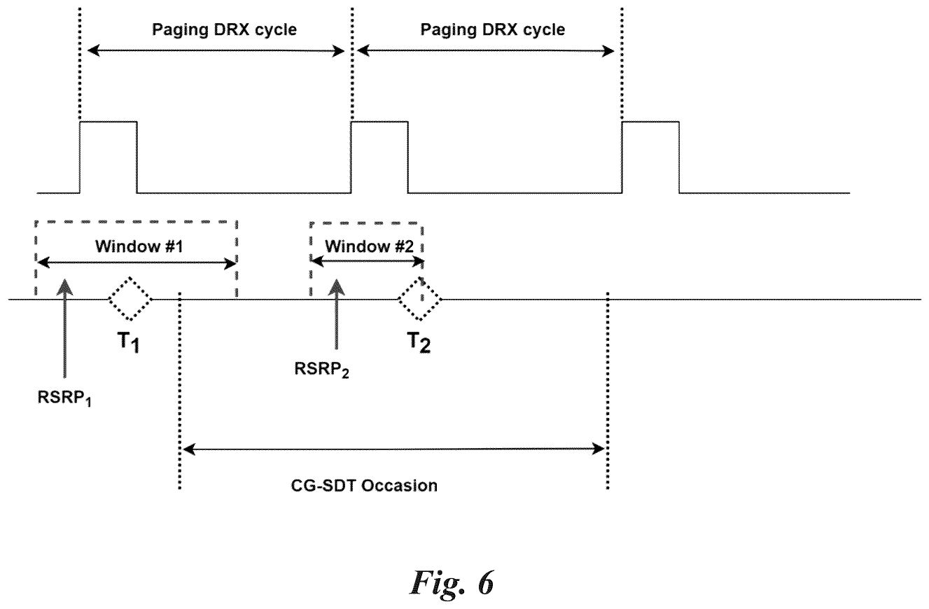

In some embodiments, before the UE can use the configured grant (CG) for a small data transfer (SDT), the UE performs a Timing Advance (TA) validation. The TA validation process includes an SDT-TATimer-based validation method that determines a specific TA timer is running and may include a Reference Signal Received Power (RSRP) change-based method that involves performing RSRP measurements during two validation windows and comparing the two Synchronization Signal Block (SSB) RSRP values. For TA validation window design, there are two window sizes and two thresholds for TA validation. Specifically, when a CG-SDT occasion is configured for a UE in RRC_INACTIVE state with a configured paging Discontinuous Reception (DRX) cycle as well. FIG. 6 illustrates the two windows defined for measuring the SSB RSRP. Referring to FIG. 6, the first window, referred to herein as Window #1, is the window centered at T1, which is the time when the latest NTA was obtained by the UE via Timing Advance Command MAC control element. RSRP1 is measured within this window. The maximum duration of the windows is ΔT1,max. It may come from the RSRP measurement due to a paging procedure, or the last RSRP measurement before the UE enters into RRC_INACTIVE state. This can be expressed as the following equation where T1′ is the time when the UE has completed SSB RSRP1:

$$( T 1 - min ( Δ T 1 , max / 2 , DRX cycle ) ) \leq T 1 ’ \leq ( T 1 + min ( Δ T 1 , max / 2 , DRX cycle ) )$$

where T1 is the time when the latest NTA was obtained by the UE via Timing Advance Command MAC control element or PDCCH for transmission on CG-SDT and T1′ is the time when the UE has completed SSB-RSRP1.

The second window, referred to herein as Window #2, ends at T2, which is the decision moment to validate TA for CG-SDT transmission. RSRP2 is measured within this window. The maximum duration of the windows is ΔT2,max. This can be expressed as the following equation where T2′ is the time when the UE has completed SSB RSRP2:

$$T 2 - min ( Δ T 2 , max , DRX cycle ) \leq T 2 ’ \leq T 2$$

where T2 is the time when the UE performs TA validation for transmission using CG-SDT, and T2′ is the time when the UE has completed SSB-RSRP2.

In summary, the TA validation methods for CG (configured grant)-SDT are as follows:
1. Method 1-SDT-TATimer-based method-in this method, a TATimer is started upon receiving the TAT-SDT configuration from base station (NW/gNB), and is (re) started upon reception of TA command. Upon the TAT expiry, the UE releases the CG-SDT resource.
2. Method 2-RSRP change-based method-in this method, two windows are created during which the UE measures RSRP1 and RSRP2 and if the RSRP change between these two values is greater than a threshold, then the UE regards the UL TA is invalid (as it may imply, for example, that the UE has moved). In this method, the highest N SSBs of all SSBs actually transmitted as indicated in SIB1 is used for RSRP-based TA validation. Nis an integer greater than 1.

In some embodiments, Method 1 is required and Method 2 is optional, and if the UE is configured for both, then both of these methods must be met before the UE can perform a CG-SDT. Note also that in order for the UE to use the CG-SDT resource for a SDT, SDT

initialization is performed and must meet certain conditions. The CG-SDT procedure is initiated by the UE only if the following SDT criteria are met:
1. The UL available SDT data amount is less than or equal to the SDT data amount threshold;
2. The downlink (DL) RSRP is greater than or equal to the configured SDT RSRP threshold (which may indicate that the cell is reliable enough to transmit the SDT);
3. The valid SDT resource is available (including an SDT-RA resource and an CG-SDT resource); and
4. The UE capability of beam correspondence shall also be considered.

In some embodiments, the measurement windows for TA validation for FR2 RSRP change based method are configured, or otherwise set up, as described below. In some embodiments, when only RSRP-Change-Threshold is configured for TA validation based on RSRP change criterion, with or without other TA validation criteria, the UE is allowed to transmit CG-SDT using the timing derived using the latest available NTA, provided that the first SSB-RSRP (RSRP1) measurement and the second SSB-RSRP (RSRP2) measurement used in the TA validation are valid measurements and timing alignment validation for transmission using CG-SDT is valid according to the all configured TA validation criteria (e.g., TAT timer is running, and RSRP change is smaller than or equal to a threshold).

In some embodiments, the RSRP1 is considered valid provided that the following condition is met for the FR2 case:

$$T 1 - min ( FR 2 - measurement - period , M \times DRX cycle ) ) \leq T 1 ’ \leq ( T 1 + min ( FR 2 - measurement - period , M \times D RX cycle ) )$$

where T1 is the time when the latest NTA was obtained by the UE via Timing Advance Command MAC control element or PDCCH for transmission on CG-SDT and T1′ is the time when the UE has completed SSB-RSRP1.

In some embodiments, with the condition above, the FR2-measurement-period is the FR2 serving cell measurement period. In such a case, in some embodiments, the FR2-measurement period is the maximum of either a predetermined length of time (e.g., 400 ms) or the Mmeas period without gaps. This is represented herein as:

$$max ( 400 ms , Mmeas\_period \_w / o\_gaps \times SMTC period )$$

The use of the maximum function enables enough time to be set to obtain a sufficient number of physical layer samples for the measurement. The 400 ms length of time is based on the number of samples needed (e.g., 5) and the by-default duty cycle of sample time, which is 80 ms in the current 5G NR (i.e., 5 samples times an 80 ms duty cycle time equals 400 ms). In other embodiments where the number of cycles and duty cycle time are different, another predetermined length of time, different from 400 ms, may be used. In some embodiments, Mmeas_period_w/o_gaps equals 24 for power classes (PCs) 2, 3, and 4 and 40 for PCs 1 and 5, and the SMTC period is the SMTC periodicity of serving cell. Note that the measurement period without gaps is the total sample number corresponding to the beam sweeping and based on existing sample numbers and is set forth in the 5G Standard.

In other embodiments, when the FR2-measurement-period is the FR2 serving cell measurement period, the FR2-measurement period is N*400 ms, where N is the scaling factor that is greater than or equal to 1. The selection of the scaling factor N allows the measurement period to be extended.

In yet other embodiments, when the FR2-measurement-period is the FR2 serving cell measurement period, the FR2-measurement period is the maximum of either a predetermined length of time (e.g., 400 ms) or a product of the UE receive (RX) beam sweeping factor, the PHY sample number for serving cell measurement, and the SMTC periodicity of serving cell. This is represented herein as:

$$max ( 400 ms , beam - sweeping - factor * PHY - sample * SMTC period ) ,$$

where the beam-sweeping-factor is the UE receive (RX) beam sweeping factor (e.g., beam-sweeping-factor equals 8) and PHY-sample is the PHY sample number for serving cell measurement (e.g., PHY-sample equals 5). The use of the beam sweeping factor, as opposed to the measurement period without gaps, takes into account the fact that in some embodiments the UE is only able to measure one carrier at a time while in the RRC inactive state and therefore this formulation allows the maximum period to be changed based on the number of physical samples being taken or number of Rx beams being swept. For example, where the number of PHY samples is 5 and the beam sweeping factor is 8, the maximum would total 40*SMTC period ms.

In some embodiments, with the condition above, the FR2-measurement-period is the measurement period considering FR2 serving cell and inter-frequency neighbor cells. In such a case, in some embodiments, the FR2-measurement period is the maximum of either the pre-defined lower boundary of the TA validation window or the product of the target carrier number for inter-frequency, the UE RX beam sweeping factor, the PHY sample number for serving cell measurement, and the SMTC periodicity of serving cell. This is represented herein as:

$$max ( \text{} Z , \text{} sharing - factor * beam - sweeping - factor * PHY - sample * SMTC period ) ,$$

where Z is a pre-defined lower boundary, sharing-factor is the target carrier number for inter-frequency, the beam-sweeping-factor is the UE receive (RX) beam sweeping factor (e.g., beam-sweeping-factor equals 8), PHY-sample is the PHY sample number for cell measurement (e.g., PHY-sample equals 5), SMTC period is either the SMTC periodicity of serving cell in some embodiments or the maximum SMTC periodicity between serving cell and inter-frequency cells in some other embodiments. As an example of the sharing-factor, if the UE has been configured with one inter-frequency carrier in the system information as well as a serving carrier, a sharing factor of 2 may be used, because measurement resource is shared between measurement for the serving carrier and the inter-frequency carrier. In some embodiments, the predetermined length of time Z may be set based on the UE duty cycle factor but may need to take into account the sharing factor and the number of other carriers of the inter-frequency neighboring cells.

In other embodiments, with the condition above and where the FR2-measurement-period is the measurement period considering FR2 serving cell and inter-frequency neighbor cells, the FR2-measurement period is a product of a scaling factor and a predetermined length of time (e.g., 400 ms). This is represented herein as:

$$N * 400 ms ,$$

where N is the scaling factor, and N is greater than or equal to 1.

In some embodiments, M is a common beam sweeping factor (e.g., 1, 2, 4, 8, etc.). Using the beam sweeping factor ensures that the beam number is guaranteed, thereby resulting in a reliable measurement of RSRP1 and an accurate RSRP change. In some other embodiments, M is a DRX based beam sweeping factor (e.g., 8 for DRX equals 320 ms, 5 for DRX equals 640 ms, 4 for DRX equals 1.28 s, 3 for DRX equals 2.56 s for PC 2/3/4 UE; and 8 for PC 1/5 UE. Note that the use of two different values for the different power classes assumes that devices in PC 1/5 are likely to move more slowly than those in PC 2/3/4.

In yet some other embodiments, M is the product of the DRX based beam sweeping factor and a power saving factor. In some embodiments, the beam sweeping factor is 8 for DRX equals 320 ms, 5 for DRX equals 640 ms, 4 for DRX equals 1.28 s, 3 for DRX equals 2.56 s for PC2/3/4 UE; and 8 for PC1/5 UE and the power saving factor equals 2 if SMTC periodicity is greater than 20 ms and the DRX is less than or equal to 640 ms, otherwise the power saving factor equals 1.

In some embodiments, RSRP2 is considered valid provided that the following condition is met for FR2 case: This is represented herein as:

$$T 2 - min ( FR 2 - measurement - period , M \times DRX cycle ) \leq T 2 ’ \leq T 2$$

where the FR2-measurement-period and M has the same definition as given above for T1, T2 is the time when the UE performs TA validation for transmission using CG-SDT, and T2′ is the time when the UE has completed SSB-RSRP2.

In some embodiments, if at least one of RSRP1 and RSRP2 is considered to be invalid based on the above conditions, then the UE shall not validate the CG-SDT using RSRP1 and RSRP2 and shall not transmit using CG-SDT. In other words, both the RSRP1 and RSRP2 must be valid for the UE to transmit using CG-SDT.

In some embodiments, the RSRP1 and RSRP2 are measured based on the highest N SSBs of all SSBs actually transmitted as indicated in SIB1. This type of measurement is done in order to improve the likelihood that the RSRP change reflects the change in round trip time associated with the communication with the base station. The highest N SSBs have different SSB indexes, and thus, the UE measures all the SSBs with different indexes.

There are a number of options that may be used to determine which are the highest N SSBs. In such a case, in some embodiments, for each SSB in the N highest SSB, the UE uses the highest RSRP value measured based on the best Rx beam of all UE local Rx beams. That is, the UE uses beam sweeping for SSB RSRP measurement, chooses the highest RSRP based on the best RX beam, and uses this RSRP to determine if this SSB is in the N highest SSBs. After collecting the N highest RSRPs for the SSBs with different SSB indexes, then these are averaged. This is performed for both measurement windows for TA validation. Thus, the highest RSRP for the RSRP1 and RSRP2 are based on the average of the RSRPs for those highest N SSBs measured in the first and second measurement windows for TA validation, respectively.

In some other embodiments, those highest N SSBs with different SSB indexes are used, and the UE uses the highest RSRP value measured based on the best Rx beam of all UE local Rx beams to determine the highest SSBs. After collecting these N highest RSRPs in the respective measurement windows for TA validation, the RSRP1 and RSRP2 are based on the top-ranked RSRP (i.e., the top RSRP with the highest measurement result) in the RSRPs of those highest N SSBs for those highest N SSBs measured in the first and second measurement windows for TA validation, respectively.

In yet some other embodiments, using those highest N SSBs with different SSB indexes and where the UE uses the highest RSRP value measured based on the best Rx beam of all UE local Rx beams, the RSRP1 and RSRP2 are based on the average RSRP of SSBs with same index in those highest N SSBs' RSRPs. For example, for the RSRP1 measurement, the top three SSBs are SSB 1, 2, 3; and for RSRP2 measurement, the top three SSBs are SSB 2, 3, 4; and the RSRP1 would be based on average of SSB 2 and three RSRPs, and the RSRP2 would be also based on average of SSB 2 and three RSRPs.

In some other embodiments, the UE uses those highest N SSBs having same or different SSB indexes and the highest RSRP value measured based on the best Rx beam of all UE local Rx beams. Thereafter, after collecting these measurements, the UE averages the RSRPs of those highest N SSBs on all Rx beams for all those SSBs that occur in each of their respective TA validation window to create RSRP1 and RSRP2 for first and second measurement windows for TA validation, respectively. Thus, RSRP1 and RSRP2 are based on the average of RSRPs of those highest N SSBs on all Rx beams for all those SSBs.

### Alternative Embodiments Regarding the UE capability for CG-SDT Initialization Applicability and Synchronization Assumption for CG-SDT Behavior

As discussed above, in some embodiments, the UE only performs an SDT after initiating the CG-SDT procedure. This requires that the UE meet certain conditions. In some embodiments, beam correspondence is included in the conditions. In other words, for the UE capability for CG-SDT initialization applicability, the CG-SDT procedure is initiated by the UE only if the following SDT criteria is fulfilled:
1. The uplink (UL) available SDT data amount is less than or equal to a SDT data amount threshold (existing condition)
2. The downlink (DL) RSRP is greater than or equal to a configured SDT RSRP threshold (existing condition)
3. The valid SDT resource is available (including the SDT-RA resource and CG-SDT resource) (existing condition)
4. The UE indicates to support beam correspondence. In some embodiments, the UE indicates to support beam correspondence when beamCorrespondence WithoutUL-BeamSweeping is indicated as 1 by the UE (newly added condition)

If the UE cannot support beam correspondence (as indicated by, for example, beamCorrespondence WithoutUL-BeamSweeping=0), then the UE drops the CG-SDT initialization, and network does not configure the UE with the capability to perform a CG-SDT. In such a case, the UE may have to use RACH-based SDT to complete the SDT.

With respect to the UE synchronization assumption for CG-SDT behavior, in some embodiments, the UE is allowed to transmit using the CG-SDT provided synchronization requirements are met. This is particularly important since the UE is in the inactive state and synchronization cannot be assumed (as in the connected mode where the UE can monitor DL reference signals and can send UL reference signals). In some embodiments, the UE is allowed to transmit using the CG-SDT provided that the UE is synchronized towards the serving cell prior to CG-SDT transmission. However, if there is no SSB available at the UE during the last Y ms, then the UE drops the CG-SDT transmission. This occurs regardless of whether the UE is configured to use one or both TA validation Methods 1 and 2 described above. For example, if a UE is configured to only use Method 1 and the TA Timer is still running, the UE may still drop the CG-SDT transmission if there is not enough time to measure the SSB.

The variable Y may have one of a number of different values. In some embodiments, Y is a predetermined length of time (e.g., 160 ms). In some other embodiments, Y equals the length of time of a DRX cycle. In yet some other embodiments, Y equals the length of time of a product of a beam-sweeping-factor multiplied by a predetermined length of time (e.g., 160 ms). In yet some other embodiments, Y equals the length of time of a product of a beam-sweeping-factor multiplied by a length of a DRX cycle. In these last two example of values of Y, the beam sweeping factor could be, for example, a common beam sweeping factor (e.g.: 1, 2, 4, 8, etc.) in one embodiment or a DRX-based beam sweeping factor (e.g., ‘8 for DRX equals 320 ms; 5 for DRX equals 640 ms; 4 for DRX equals 1.28 s; 3 for DRX equals 2.56 s’ for PC2/3/4 UE, and 8 for PC1/5 UE). Note that ‘SSB is available’ means the SSB is received by UE and its RSRP is not lower than the configured SDT RSRP threshold.

Note that these alternative embodiments may be used in conjunction with the TA window embodiments described above. However, in other embodiments, they may be used with the TA Timer-based validation method without the RSRP change-based validation method.

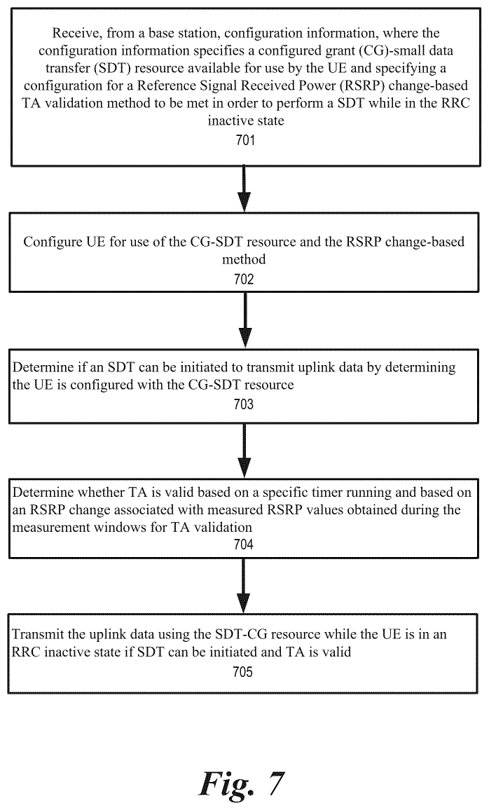

FIG. 7 is a flow diagram of an embodiment of a process for wireless communication at a user equipment (UE). The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system.

Referring to FIG. 7, the process begins by processing logic receiving, from a base station, configuration information, where the configuration information specifies a small data transfer (SDT)-configured grant (CG) resource available for use by the UE and specifies a configuration for Reference Signal Received Power (RSRP) change-based TA validation to be met in order to perform a SDT while in the RRC inactive state (processing block 701). In some embodiments, the RSRP change-based TA validation uses configured TA validation criteria that is evaluated based on two timing advance (TA) validation windows, with at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period.

In some embodiments, boundaries of one of the measurement windows for TA validation include: a first time (e.g., T1) minus the minimum of either the FR2 measurement period and a product of a first scaling factor and a DRX cycle period, existing at TA validation criteria evaluation, and a second time equal to the first time (e.g., T1) plus the minimum of either the FR2 measurement period and the scaled version of the DRX cycle period, existing at time of TA validation criteria evaluation. In some embodiments, the first time is a time when the latest NTA was obtained by the UE via a TA Command MAC control element or PDCCH for transmission on the CG-SDT resource. In some embodiments, the first scaling factor (e.g., M) is one selected from a group consisting of a common beam sweeping factor, a DRX-beam sweeping factor, or a product of the DRX-beam sweeping factor and a power savings factor.

In some embodiments, the FR2 measurement period comprises a FR2 serving cell measurement period. In some embodiments, the FR2 serving cell measurement period comprises one selected from a group consisting of: a maximum of either a predetermined value or a measurement period without gaps multiplied by a SSB-based RRM Measurement Timing Configuration (SMTC) periodicity of the serving cell; or a first predetermined amount of time multiplied by a second scaling factor; or a maximum of either a second predetermined amount of time or a product of a beam sweeping factor, a physical (PHY) sample number for cell measurement, and either the SMTC periodicity of the serving cell in some embodiments or a maximum SMTC periodicity between the serving cell and inter-frequency cells in some other embodiments.

In some embodiments, the FR2 measurement period considers both a FR2 serving cell measurement period and inter-frequency cells. In some embodiments, the FR2 serving cell measurement period comprises one selected from a group consisting of: a maximum of either a predefined lower boundary or a product of a sharing factor representing a target carrier number for inter-frequency, a beam sweeping factor, a physical (PHY) sample number for cell measurement, and either the SMTC periodicity of the serving cell in some embodiments or a maximum SMTC periodicity between the serving cell and inter-frequency cells in some other embodiments; or a first predetermined amount of time multiplied by a second scaling factor.

In some embodiments, boundaries of one of the measurement windows for TA validation include: a first time (e.g., T2) equal to a time when the UE performs TA validation for transmission using CG-SDT resource; and second time equal to first time (e.g., T2) less a minimum of either the FR2 measurement period and a product of a first scaling factor and a DRX cycle period, existing at TA validation criteria evaluation.

Referring back to FIG. 7, in response to the configuration information, processing logic of the UE configures the UE to use the CG-SDT resource and the RSRP change-based TA validation (processing block 702).

After configuration, processing logic determines if an SDT can be initiated to transmit uplink data by determining the UE is configured with the CG-SDT resource (processing block 703) and determines whether TA is valid based on an RSRP change associated with measured RSRP values obtained during the measurement windows for TA validation (processing block 704). In some embodiments, processing logic determines whether the TA is valid based on whether a specific timer (e.g., TATimer) running.

In one embodiment, processing logic determines whether TA is valid based on an RSRP change associated with measured RSRP values obtained during the measurement windows for TA validation by measuring first and second RSRP values during a first and second windows, respectively, of the measurement windows for TA validation.

In some embodiments, determining if an SDT can be initiated to transmit uplink data comprises determining whether the UE supports beam correspondence, and the SDT is initiated only if the UE supports beam correspondence.

In some embodiments, determining if an SDT can be initiated to transmit uplink data comprises determining whether the UE is synchronized towards the serving cell prior to CG-SDT transmission, and the CG-SDT transmission is dropped if no Synchronization Signal Block (SSB) is available at the UE during a last predetermined length of time. In some embodiments, the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

In some embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average of RSRPs of the highest N SSBs. In some other embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on a top-ranked RSRP of the highest N SSBs. In yet some other embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with a same index in the highest N SSBs.

Processing logic transmits the uplink data using the CG-SDT resource while the UE is in an RRC inactive state if TA is valid (processing block 705). In some embodiments, processing logic transmits the uplink data using the CG-SDT resource while the UE is in an RRC inactive state if an SDT can be initiated and TA is valid.

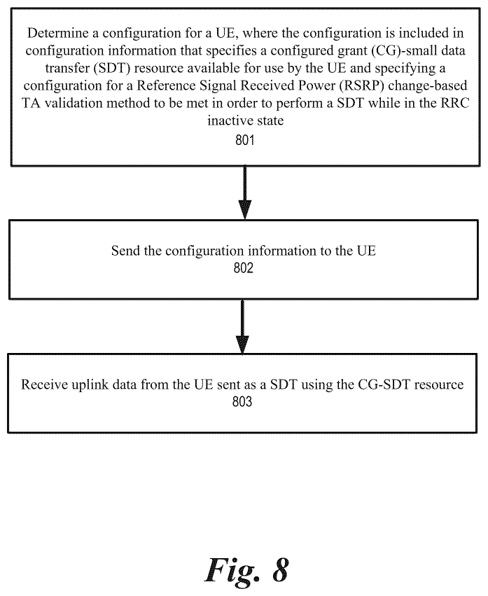

FIG. 8 is a flow diagram of an embodiment of a process for wireless communication at a base station. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a base station in a 5G NR communication system.

Referring to FIG. 8, the process begins by processing logic determining a configuration for a UE, where the configuration is included in configuration information that specifies a small data transfer (SDT)-configured grant (CG) resource available for use by the UE and specifies a configuration for Reference Signal Received Power (RSRP) change-based TA validation to be met in order to perform a SDT while in the RRC inactive state (processing block 801). In some embodiments, the RSRP change-based TA validation uses configured TA validation criteria that is evaluated based on two timing advance (TA) validation windows, and at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period.

In some embodiments, boundaries of one of the measurement windows for TA validation include: a first time (e.g., T1) minus the minimum of either the FR2 measurement period and a product of a first scaling factor and a DRX cycle period, existing at TA validation criteria evaluation, and a second time equal to the first time (e.g., T1) plus the minimum of either the FR2 measurement period and the scaled version of the DRX cycle period, existing at time of TA validation criteria evaluation. In some embodiments, the first time is a time when the latest NTA was obtained by the UE via a TA Command MAC control element or PDCCH for transmission on the CG-SDT resource. In some embodiments, the first scaling factor (e.g., M) is one selected from a group consisting of a common beam sweeping factor, a DRX-beam sweeping factor, or a product of the DRX-beam sweeping factor and a power savings factor.

In some embodiments, the FR2 measurement period comprises a FR2 serving cell measurement period. In some embodiments, the FR2 serving cell measurement period comprises one selected from a group consisting of: a maximum of either a predetermined value or a measurement period without gaps multiplied by a SSB-based RRM Measurement Timing Configuration (SMTC) periodicity of the serving cell; or a first predetermined amount of time multiplied by a second scaling factor; or a maximum of either a second predetermined amount of time or a product of a beam sweeping factor, a physical (PHY) sample number for cell measurement, and either the SMTC periodicity of the serving cell in some embodiments or a maximum SMTC periodicity between the serving cell and inter-frequency cells in some other embodiments.

In some embodiments, the FR2 measurement period considers both a FR2 serving cell measurement period and inter-frequency cells. In some embodiments, the FR2 serving cell measurement period comprises one selected from a group consisting of: a maximum of either a predefined lower boundary or a product of a sharing factor representing a target carrier number for inter-frequency, a beam sweeping factor, a physical (PHY) sample number for cell measurement, and either the SMTC periodicity of the serving cell in some embodiments or a maximum SMTC periodicity between the serving cell and inter-frequency cells in some other embodiments; or a first predetermined amount of time multiplied by a second scaling factor.

In some embodiments, boundaries of one of the measurement windows for TA validation include: a first time (e.g., T2) equal to a time when the UE performs TA validation for transmission using CG-SDT resource; and second time equal to first time (e.g., T2) less a minimum of either the FR2 measurement period and a product of a first scaling factor and a DRX cycle period, existing at TA validation criteria evaluation.

After the UE is configured, the UE is able to determine if an SDT can be initiated to transmit uplink data by determining the UE is configured with the CG-SDT resource and determining whether TA is valid based on a specific timer running and based on an RSRP change associated with measured RSRP values obtained during the measurement windows for TA validation.

In one embodiment, processing logic determines whether TA is valid based on an RSRP change associated with measured RSRP values obtained during the measurement windows for TA validation by measuring first and second RSRP values during a first and second windows, respectively, of the measurement windows for TA validation.

In some embodiments, determining if an SDT can be initiated to transmit uplink data comprises determining whether the UE supports beam correspondence, and the SDT is initiated only if the UE supports beam correspondence.

In some embodiments, determining if an SDT can be initiated to transmit uplink data comprises determining whether the UE is synchronized towards the serving cell prior to CG-SDT transmission, and the CG-SDT transmission is dropped if no Synchronization Signal Block (SSB) is available at the UE during a last predetermined length of time. In some embodiments, the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

In some embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average of RSRPs of the highest N SSBs. In some other embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on a top-ranked RSRP of the highest N SSBs. In yet some other embodiments, the measured RSRP values for the measurement windows for TA validation are obtained by measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with a same index in the highest N SSBs.

After determining the configuration information, processing logic sends the configuration information to the UE (processing block 802) and thereafter receives uplink data from the UE sent as a SDT using the CG-SDT resource (processing block 803).

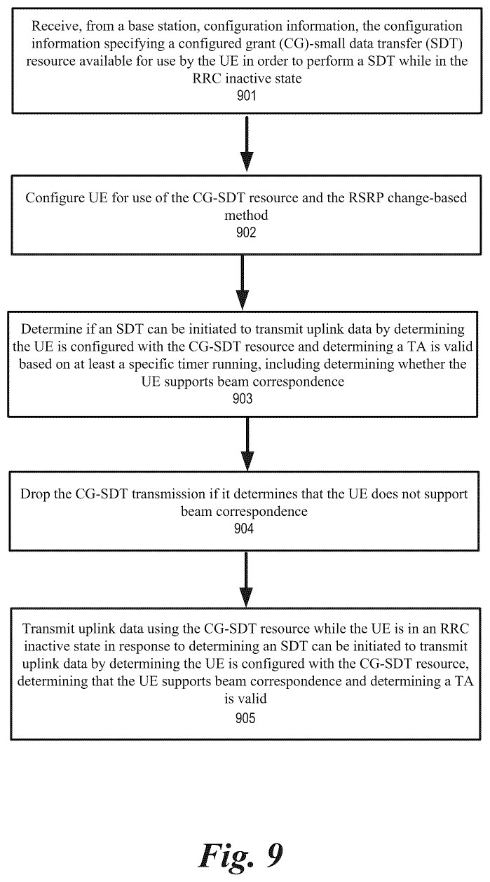

FIG. 9 is a flow diagram of an embodiment of a process for wireless communication at a user equipment (UE). The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system.

Referring to FIG. 9, the process begins by processing logic receiving, from a base station, configuration information, the configuration information specifying a small data transfer (SDT)-configured grant (CG) resource available for use by the UE in order to perform a SDT while in the RRC inactive state (processing block 901). In response to the configuration information, processing logic configures itself for use of the CG-SDT resource and the RSRP change-based method (processing block 902).

Thereafter, processing logic determines if an SDT can be initiated to transmit uplink data by determining the UE is configured with the CG-SDT resource and determining a TA is valid based on at least a specific timer (e.g., a TATimer) running, including determining whether the UE supports beam correspondence (processing block 903). In some embodiments, the SDT is initiated only if the UE supports beam correspondence.

Processing logic drops the CG-SDT transmission if it determines that the UE does not support beam correspondence (processing block 904).

Processing logic transmits uplink data using the CG-SDT resource while the UE is in an RRC inactive state in response to determining an SDT can be initiated to transmit uplink data. This may be determined by determining the UE is configured with the CG-SDT resource, determining that the UE supports beam correspondence and determining TA is valid (processing logic 905).

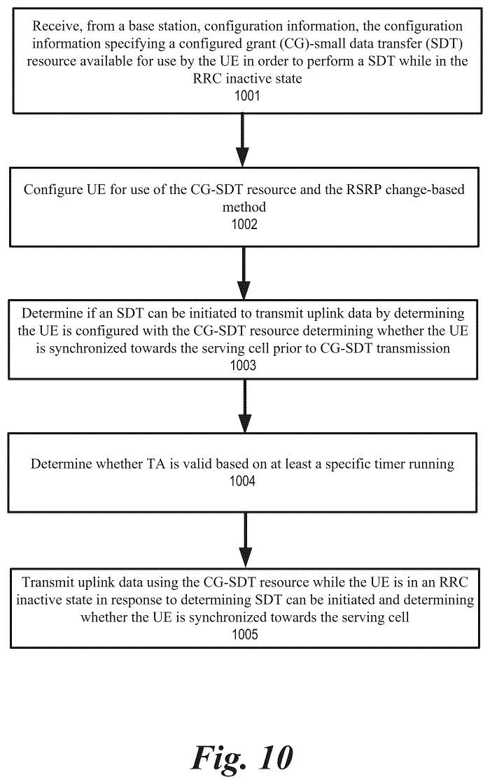

FIG. 10 is a flow diagram of an embodiment of a process for wireless

communication at a user equipment (UE). The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system.

Referring to FIG. 10, the process begins by processing logic receiving, from a base station, configuration information, the configuration information specifying a small data transfer (SDT)-configured grant (CG) resource available for use by the UE in order to perform a SDT while in the RRC inactive state (processing block 1001). In response to the configuration information, processing logic configures itself for use of the CG-SDT resource and the RSRP change-based method (processing block 1002).

Thereafter, processing logic determines if an SDT can be initiated to transmit uplink data by determining the UE is configured with the CG-SDT resource determining whether the UE is synchronized towards the serving cell prior to CG-SDT transmission (processing block 1003) and determines whether TA is valid based on at least a specific timer running (processing block 1004). In some embodiments, the UE determines that the UE is not synchronized towards the serving cell if no Synchronization Signal Block (SSB) is available at the UE during a last predetermined length of time. In some embodiments, the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

Processing logic transmits uplink data using the CG-SDT resource while the UE is in an RRC inactive state in response to determining SDT can be initiated and determining whether the UE is synchronized towards the serving cell (processing logic 1005).

Processing logic drops the CG-SDT transmission if it determines that the UE is not synchronized towards the serving cell (processing block 1006).

There are a number of example embodiments described herein.

Example 1 is a method for wireless communication at a user equipment (UE), the method comprising: receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; determining whether a TA is valid based on an RSRP change associated with measured RSRP values obtained during the measurement windows for TA validation; and transmitting, in response to determining the TA is valid, uplink data using a configured grant (CG)-SDT (CG-SDT) resource while the UE is in an RRC inactive state.

Example 2 is the method of example 1 that may optionally include that wherein boundaries of one of the measurement windows for TA validation include: a first time minus the minimum of either the FR2 measurement period and a product of a first scaling factor and a DRX cycle period, existing at TA validation criteria evaluation, and a second time equal to the first time plus the minimum of either the FR2 measurement period and the scaled version of the DRX cycle period, existing at time of TA validation criteria evaluation.

Example 3 is the method of example 2 that may optionally include that the first time is a time when the latest NTA was obtained by the UE via a TA Command MAC control element or PDCCH for transmission on the CG-SDT resource.

Example 4 is the method of example 2 that may optionally include that the FR2 measurement period comprises a FR2 serving cell measurement period.

Example 5 is the method of example 4 that may optionally include that the FR2 serving cell measurement period comprises one selected from a group consisting of: a maximum of either a predetermined value or a measurement period without gaps multiplied by a SSB-based Measurement Timing Configuration (SMTC) periodicity of the serving cell; or a first predetermined amount of time multiplied by a second scaling factor; or a maximum of either a second predetermined amount of time or a product of a beam sweeping factor, a physical (PHY) sample number for cell measurement, and the SMTC periodicity of the serving cell or a maximum SMTC periodicity between the serving cell and inter-frequency cells.

Example 6 is the method of example 2 that may optionally include that the FR2 measurement period considering a FR2 serving cell measurement period and inter-frequency cells.

Example 7 is the method of example 6 that may optionally include that the FR2 serving cell measurement period comprises one selected from a group consisting of: a maximum of either a predefined lower boundary or a product of a sharing factor representing a target carrier number for inter-frequency, a beam sweeping factor, a physical (PHY) sample number for cell measurement, and the SMTC periodicity of the serving cell or a maximum SMTC periodicity between the serving cell and inter-frequency cells; or a first predetermined amount of time multiplied by a second scaling factor.

Example 8 is the method of example 2 that may optionally include that the first scaling factor is one selected from a group consisting of a common beam sweeping factor, a DRX-beam sweeping factor, or a product of the DRX-beam sweeping factor and a power savings factor.

Example 9 is the method of example 1 that may optionally include that boundaries of one of the measurement windows for TA validation include: a first time equal to a time when the UE performs TA validation for transmission using CG-SDT resource; and a second time equal to first time minus a minimum of either the FR2 measurement period and a product of a first scaling factor and a DRX cycle period, existing at TA validation criteria evaluation.

Example 10 is the method of example 1 that may optionally include measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average of RSRPs of the highest N SSBs.

Example 11 is the method of example 1 that may optionally include measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on a top-ranked RSRP of the highest N SSBs.

Example 12 is the method of example 1 that may optionally include that measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with a same index in the highest N SSBs.

Example 13 is the method of example 1 that may optionally include measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with same or different indices in the highest N SSBs.

Example 14 is the method of example 1 that may optionally include determining if the SDT can be initiated to transmit the uplink data, wherein determining if an SDT can be initiated to transmit uplink data comprises determining whether the UE supports beam correspondence, the SDT being initiated only if the UE supports beam correspondence.

Example 15 is the method of example 1 that may optionally include determining if the SDT can be initiated to transmit the uplink data, wherein determining if an SDT can be initiated to transmit uplink data comprises determining whether the UE is synchronized towards the serving cell prior to CG-SDT transmission, and further comprising: dropping the CG-SDT transmission if no Synchronization Signal Block (SSB) is available at the UE during a last predetermined length of time.

Example 16 is the method of example 15 that may optionally include that the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

Example 17 is a baseband processor of a User Equipment (UE) configured to perform operations of: receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; determining whether a TA is valid based on an RSRP change associated with measured RSRP values obtained during the measurement windows for TA validation; and transmitting, in response to determining the TA is valid, uplink data using a configured grant (CG)-SDT (CG-SDT) resource while the UE is in an RRC inactive state.

Example 18 is the baseband processor of example 17 that may optionally include that the one or more processors perform operations associated with one or more of the methods of examples 2-16.

Example 19 is a UE comprising one or more processors configured to perform operations comprising: receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; determining whether a TA is valid based on an RSRP change associated with measured RSRP values obtained during the measurement windows for TA validation; and transmitting, in response to determining the TA is valid, uplink data using a configured grant (CG)-SDT (CG-SDT) resource while the UE is in an RRC inactive state.

Example 20 is the UE of example 19 that may optionally include that the one or more processors perform operations associated with one or more of the methods of examples 2-16.

Example 21 is a method for use in a base station, the method comprising: determining a configuration for a UE, wherein the configuration is included in configuration information that specifies a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; sending the configuration information to the UE; and receiving uplink data from the UE sent as a SDT using a configured grant (CG)-SDT (CG-SDT) resource.

Example 22 is the method of example 21 that may optionally include that boundaries of one of the measurement windows for TA validation include: a first time minus the minimum of either the FR2 measurement period and a product of a first scaling factor and a DRX cycle period, existing at TA validation criteria evaluation, and a second time equal to the first time plus the minimum of either the FR2 measurement period and the scaled version of the DRX cycle period, existing at time of TA validation criteria evaluation.

Example 23 is the method of example 22 that may optionally include that the first time is a time when the latest NTA was obtained by the UE via a TA Command MAC control element or PDCCH for transmission on the CG-SDT resource.

Example 24 is the method of example 22 that may optionally include that the FR2 measurement period comprises a FR2 serving cell measurement period.

Example 25 is the method of example 24 that may optionally include that the FR2 serving cell measurement period comprises one selected from a group consisting of: a maximum of either a predetermined value or a measurement period without gaps multiplied by a SSB-based Measurement Timing Configuration (SMTC) periodicity of the serving cell; or a first predetermined amount of time multiplied by a second scaling factor; or a maximum of either a second predetermined amount of time or a product of a beam sweeping factor, a physical (PHY) sample number for cell measurement, and the SMTC periodicity of the serving cell or a maximum SMTC periodicity between the serving cell and inter-frequency cells.

Example 26 is the method of example 22 that may optionally include that the FR2 measurement period considering a FR2 serving cell measurement period and inter-frequency cells.

Example 27 is the method of example 26 that may optionally include that the FR2 serving cell measurement period comprises one selected from a group consisting of: a maximum of either a predefined lower boundary or a product of a sharing factor representing a target carrier number for inter-frequency, a beam sweeping factor, a physical (PHY) sample number for cell measurement, and the SMTC periodicity of the serving cell or a maximum SMTC periodicity between the serving cell and inter-frequency cells; or a first predetermined amount of time multiplied by a second scaling factor.

Example 28 is the method of example 22 that may optionally include that the first scaling factor is one selected from a group consisting of a common beam sweeping factor, a DRX-beam sweeping factor, or a product of the DRX-beam sweeping factor and a power savings factor.

Example 29 is the method of example 21 that may optionally include that boundaries of one of the measurement windows for TA validation include: a first time equal to a time when the UE performs TA validation for transmission using CG-SDT resource; and a second time equal to first time minus a minimum of either the FR2 measurement period and a product of a first scaling factor and a DRX cycle period, existing at TA validation criteria evaluation.

Example 30 is the method of example 11 that may optionally include that the RSRP change-based TA validation method measures first and second RSRP values during a first and second windows of the measurement windows for TA validation, respectively, based on the highest N Synchronization Signal Blocks (SSBs) of all transmitted SSBs, where Nis an integer, wherein the first and second RSRP values are based on an average of RSRPs of the highest N SSBs.

Example 31 is the method of example 21 that may optionally include that the RSRP change-based TA validation method measures first and second RSRP values during a first and second windows of the measurement windows for TA validation, respectively, based on the highest N Synchronization Signal Blocks (SSBs) of all transmitted SSBs, where N is an integer, wherein the first and second RSRP values are based on a top-ranked RSRP of the highest N SSBs.

Example 32 is the method of example 21 that may optionally include that the RSRP change-based TA validation method measures first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with a same index in the highest N SSBs.

Example 33 is the method of example 21 that may optionally include measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with same or different indices in the highest N SSBs.

Example 34 is the method of example 21 that may optionally include determining if the SDT can be initiated to transmit the uplink data, wherein an SDT can be initiated to transmit uplink data comprises determining whether the UE supports beam correspondence, the SDT being initiated only if the UE supports beam correspondence.

Example 35 is the method of example 21 that may optionally include determining if the SDT can be initiated to transmit the uplink data, wherein an SDT can be initiated to transmit uplink data comprises determining whether the UE is synchronized towards the serving cell prior to CG-SDT transmission, and further comprising: dropping the CG-SDT transmission if no Synchronization Signal Block (SSB) is available at the UE during a last predetermined length of time.

Example 36 is the method of 35 that may optionally include that the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

Example 37 is a base station comprising one or more processors configured to perform operations comprising: determining a configuration for a UE, wherein the configuration is included in configuration information that specifies a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; sending the configuration information to the UE; and receiving uplink data from the UE sent as a SDT using a configured grant (CG)-SDT (CG-SDT) resource.

Example 38 is the base station of example 37 that may optionally include that the one or more processors are configured to perform operations associated with one or more of the methods of examples 22-36.

Example 39 is a baseband processor of a base station configured to perform operations comprising: determining a configuration for a UE, wherein the configuration is included in configuration information that specifies a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; sending the configuration information to the UE; and receiving uplink data from the UE sent as a SDT using a configured grant (CG)-SDT (CG-SDT) resource.

Example 40 is the baseband processor of example 39 that may optionally include that the one or more processors are configured to perform operations associated with one or more of the methods of examples 22-36.

Example 41 is a method for wireless communication at a user equipment (UE), the method comprising: receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; determining if the SDT can be initiated to transmit the uplink data, wherein determining if an SDT can be initiated to transmit uplink data comprises determining whether the UE supports beam correspondence, the SDT being initiated only if the UE supports beam correspondence, determining whether a TA is valid based on an RSRP change associated with measured RSRP values obtained during the measurement windows for TA validation; and transmitting, in response to determining the TA is valid, uplink data using a configured grant (CG)-SDT (CG-SDT) resource while the UE is in an RRC inactive state.

Example 42 is a method for wireless communication at a user equipment (UE), the method comprising: receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period; determining if the SDT can be initiated to transmit the uplink data, including determining whether the UE is synchronized towards the serving cell prior to CG-SDT transmission, dropping the CG-SDT transmission if no Synchronization Signal Block (SSB) is available at the UE during a last predetermined length of time, and determining, if the UE is synchronized towards the serving cell prior to CG-SDT transmission, whether a TA is valid based on an RSRP change associated with measured RSRP values obtained during the measurement windows for TA validation; and transmitting, in response to determining the TA is valid, uplink data using a configured grant (CG)-SDT (CG-SDT) resource while the UE is in an RRC inactive state.

Example 43 is the method of example 42 that may optionally include that the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A baseband processor of a User Equipment (UE) configured to perform operations of:
receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period;
determining whether a TA is valid based on an RSRP change associated with measured RSRP values obtained during the measurement windows for TA validation; and
transmitting, in response to determining the TA is valid, uplink data using a configured grant (CG)-SDT (CG-SDT) resource while the UE is in an RRC inactive state.

2. The baseband processor of claim 1 wherein boundaries of one of the measurement windows for TA validation include:
a first time minus the minimum of either the FR2 measurement period and a product of a first scaling factor and a DRX cycle period, existing at TA validation criteria evaluation, and
a second time equal to the first time plus the minimum of either the FR2 measurement period and the scaled version of the DRX cycle period, existing at time of TA validation criteria evaluation.

3. The baseband processor of claim 2 wherein the first time is a time when the latest NTA was obtained by the UE via a TA Command MAC control element or PDCCH for transmission on the CG-SDT resource.

4. The baseband processor of claim 2 wherein the FR2 measurement period comprises a FR2 serving cell measurement period.

5. The baseband processor of claim 4 wherein the FR2 serving cell measurement period comprises one selected from a group consisting of:
a maximum of either a predetermined value or a measurement period without gaps multiplied by a SSB-based Measurement Timing Configuration (SMTC) periodicity of the serving cell; or
a first predetermined amount of time multiplied by a second scaling factor; or
a maximum of either a second predetermined amount of time or a product of a beam sweeping factor, a physical (PHY) sample number for cell measurement, and the SMTC periodicity of the serving cell or a maximum SMTC periodicity between the serving cell and inter-frequency cells.

6. The baseband processor of claim 2 wherein the FR2 measurement period considering a FR2 serving cell measurement period and inter-frequency cells.

7. The baseband processor of claim 6 wherein the FR2 serving cell measurement period comprises one selected from a group consisting of:
a maximum of either a predefined lower boundary or a product of a sharing factor representing a target carrier number for inter-frequency, a beam sweeping factor, a physical (PHY) sample number for cell measurement, and the SMTC periodicity of the serving cell or a maximum SMTC periodicity between the serving cell and inter-frequency cells; or
a first predetermined amount of time multiplied by a second scaling factor.

8. The baseband processor of claim 2 wherein the first scaling factor is one selected from a group consisting of a common beam sweeping factor, a DRX-beam sweeping factor, or a product of the DRX-beam sweeping factor and a power savings factor.

9. The baseband processor of claim 1 wherein boundaries of one of the measurement windows for TA validation include:
a first time equal to a time when the UE performs TA validation for transmission using CG-SDT resource; and
a second time equal to first time minus a minimum of either the FR2 measurement period and a product of a first scaling factor and a DRX cycle period, existing at TA validation criteria evaluation.

10. The baseband processor of claim 1 wherein the operations further comprise measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average of RSRPs of the highest N SSBs.

11. The baseband processor of claim 1 wherein the operations further comprise measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on a top-ranked RSRP of the highest N SSBs.

12. The baseband processor of claim 1 wherein the operations further comprise measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with a same index in the highest N SSBs.

13. The baseband processor of claim 1 wherein the operations further comprise measuring first and second RSRP values during a first and second windows of the measurement windows for TA validation, respectively, based on the highest N Synchronization Signal Blocks (SSBs) of all transmitted SSBs, where N is an integer, wherein the first and second RSRP values are based on an average RSRP of SSBs with same or different indices in the highest N SSBs.

14. The baseband processor of claim 1 wherein the operations further comprise determining if the SDT can be initiated to transmit the uplink data, wherein determining if an SDT can be initiated to transmit uplink data comprises determining whether the UE supports beam correspondence, the SDT being initiated only if the UE supports beam correspondence.

15. The baseband processor of claim 1 wherein the operations further comprise determining if the SDT can be initiated to transmit the uplink data, wherein determining if an SDT can be initiated to transmit uplink data comprises determining whether the UE is synchronized towards the serving cell prior to CG-SDT transmission, and further comprising:
dropping the CG-SDT transmission if no Synchronization Signal Block (SSB) is available at the UE during a last predetermined length of time.

16. The baseband processor of claim 15 wherein the predetermined length of time comprises one selected from a group consisting of: a predefined length of time, a length of a DRX cycle, a first length of time equal to a beam sweeping factor multiplied by a predetermined number, or a second length of time equal to a beam sweeping factor multiplied by the length of the DRX cycle.

17. A method for wireless communication at a user equipment (UE), the method comprising:
receiving, from a base station, configuration information, the configuration information specifying a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period;
determining whether a TA is valid based on an RSRP change associated with measured RSRP values obtained during the measurement windows for TA validation; and
transmitting, in response to determining the TA is valid, uplink data using a configured grant (CG)-SDT (CG-SDT) resource while the UE is in an RRC inactive state.

18. The method of claim 17 wherein boundaries of one of the measurement windows for TA validation include:
a first time minus the minimum of either the FR2 measurement period and a product of a first scaling factor and a DRX cycle period, existing at TA validation criteria evaluation, and
a second time equal to the first time plus the minimum of either the FR2 measurement period and the scaled version of the DRX cycle period, existing at time of TA validation criteria evaluation.

19. A base station configured to perform operations of:
determining a configuration for a UE, wherein the configuration is included in configuration information that specifies a configuration for Reference Signal Received Power (RSRP) change-based TA validation to be met in order to perform a small data transfer (SDT) while in the RRC inactive state, the RSRP change-based TA validation using configured TA validation criteria that is evaluated based on two measurement windows for timing advance (TA) validation, at least one boundary of at least one of the two measurement windows for TA validation being based on a minimum, existing at time of TA validation criteria evaluation, of either a Frequency Range 2 (FR2) measurement period and a scaled Discontinuous Reception (DRX) cycle period;
sending the configuration information to the UE; and
receiving uplink data from the UE sent as a SDT using a configured grant (CG)-SDT (CG-SDT) resource.
